(19) United States
(12) Patent Application Publication
(10) Pub. No.: US 2009/0184643 A1
(43) Pub. Date: Jul. 23, 2009

(54) ELECTRODE UNIT IN HIGH PRESSURE DISCHARGE LAMP

(75) Inventors: James D. Hooker, Aarschot (BE); Carlo Vlekken, Halen (BE); Walter Schaaf, Diest (BE); Rudy Geens, Heusden-Zolder (BE)

Correspondence Address: BROOKS KUSHMAN P.C., 1000 TOWN CENTER, TWENTY-SECOND FLOOR, SOUTHFIELD, MI, 48075, US

(73) Assignee: FLOWIL INTERNATIONAL LIGHTING (HOLDING) B.V., Amsterdam (NL)

(21) Appl. No.: 12/354,847

(22) Filed: Jan. 16, 2009

(30) Foreign Application Priority Data
Jan. 18, 2008 (EP) 08100652.0

(51) Int. Cl. H01J 61/04; H01J 9/00

(52) U.S. Cl. 313/631; 445/46

(57) ABSTRACT

A combined cermet rod and electrode unit for use in a high pressure discharge lamp comprising a cermet rod for connection at its distal end to an electrode tip of the high pressure discharge lamp, and a current supply electrode for forming an electrical connection with the cermet rod. The current supply electrode is formed with a hollow tubular section which is positioned around a proximal end of the cermet rod in physical and electrical contact therewith.

### FIELD OF THE INVENTION

The present invention relates to the field of high pressure discharge lamps, and in particular to electrodes for connecting electrical power through to the discharge tip of such a lamp.

### BACKGROUND OF THE INVENTION

Many different forms of electric lamp are well known, and these range from simple incandescent lamps which produce light as a result of current flowing through a high resistance coil, to other designs wherein electric current is passed through a gas which in turn produces a light discharge. The present invention is particularly related to high pressure discharge lamps, typically those utilizing one of the halide vapours. By passing a current through a halide gas rich atmosphere, electron transitions in the atoms of the gas lead to a variety of different wavelengths of light to be emitted.

It is common for high pressure discharge lamps of the type relevant for the current invention to be made from a ceramic material, as these have advantageous properties for housing the halide gases as well as for providing the required electrical isolation of the current passing through the gas. Further, when current flows through the lamp, parts of the lamp tend to become hot; ceramic materials are well known for having good resilience to such high temperatures and are desirable materials. With the use of ceramic tubes for holding the halide gases, it becomes necessary to provide a means by which an electrical current can be passed into the bulb of the ceramic lamp, and in particular to a discharge electrode tip therein. Normally, two discharge electrode tips are placed within the bulb of a discharge lamp, and the electrical discharge from one tip passes through the gas to the other tip to the electrical circuit.

Typically, at the ends of the ceramic discharge tube are provided two channels with a central bore therethrough, along which the electrical connection is provided. These extensions, or protruding plugs, provide a conduit through which an electrically conductive medium can be placed in order to transfer current from a current source through to the electric discharge tips. It is further advantageous to utilize a cermet material for providing the electrical connection along the bore of the protruding plug, as this material generally has similar temperature expansion properties as the ceramic discharge tube. That is, as the tube is in use and it heats up, if a cermet rod is used as the electric connection through to the discharge electrode tip, it will generally expand and contract in the same manner as the ceramic discharge tube. This is particularly advantageous as the protruding plugs on the tube tend to be quite delicate, and if the electrode were to expand at a greater rate or to a greater degree than the protruding plug, this could cause damage to the protruding plug and tube.

Utilizing a cermet rod in a protruding plug of a discharge lamp does have advantageous properties, but leads to further difficulties. It is necessary to provide a metallic connection to the outside of the lamp for connection of the driving electronic unit to the lamp itself. It is possible to weld metallic electrode materials to the cermet rod. Unfortunately, this has a significant drawback of leading to embrittlement of the material, which impacts on the resilience of the lamp in general. Several prior art techniques have attempted to overcome this problem in a variety of different ways. For example, in EP 0 587 238, a weld is made between the metallic electrode and the cermet rod, and this weld is then housed within the protruding plug of the discharge lamp. Whilst housing the weld within the protruding plug region reduces the chance of breakage of the brittle cermet rod, it is not desirable to have a metal material within the protruding plug. As has been discussed above, the protruding plugs at the ends of discharge lamps are generally quite delicate in themselves, and the inclusion of a metal material as an electrode leads to damage if the metal becomes too hot and expands too rapidly. Further, this metal electrode is generally held within a seal at the end of the protruding plug to enclose the atmosphere within the bulb itself, and again seal failure can occur if the metal electrode expands too much or too rapidly. Also the seal length must be long, resulting in increased lamp length.

A further technique has been proposed in Japanese Patent Application No. 2001292763. In this application, the weld between the metallic electrode and the cermet rod is not held within the protruding plug of the lamp. Rather, the weld is outside of the protruding plug, and a further additional reinforcing member is placed at the end of the protruding plug over the weld region. Again, it is necessary to properly seal the whole region at the end of the protruding plug, which includes the region between the reinforcing member and the end of the cermet rod and the metallic electrode. Once more, this means an increased lamp length and the seal is present around the metallic part of the electrode, which when the lamp is in use, can lead to failure. Further, this technique of protecting the weld joint is extremely complex, in that it requires the provision of the further reinforcing member.

### RESUME OF THE INVENTION

The present invention is proposed in order to overcome the difficulties associated with connecting between a metallic material and the cermet rod, and the embrittlement of the cermet rod which occurs as a result of a weld. Further, the current invention provides for a simple structure which has the added advantage of being able to locate the discharge electrode tip at the precise desired position within the bulb region of the lamp. The above problems as well as further advantages are achieved in the present invention by means of a combined cermet rod and electrode unit. This combined cermet rod and electrode unit comprises a cermet rod which is for connecting to an electrode tip at its distal end for use in a high pressure discharge lamp. Further, at the proximal end of the cermet rod, a current supply electrode is electrically connected in order to allow ready electrical connection to the cermet rod for an external current source. The current supply electrode is generally structured to include a hollow tubular section which is positioned over and around the proximal end of the cermet rod, and in particular is in both physical and electrical contact therewith.

Preferably, the current supply electrode has a hollow tubular section which has an internal diameter which is approximately equal to the external diameter of the cermet rod. This will obviously facilitate the connection between the current supply electrode and the cermet rod, by giving a close fit once the electrode is slid over the proximal end of the cermet rod. Further, it is possible to fix together the cermet rod and the supply electrode by means of a weld joint at the very proximal end of the cermet rod. By positioning the weld joint at the very end of the cermet rod, and having more of the supply electrode extending along the outer surface of the cermet rod therefrom, the embrittled region of the cermet rod is inherently strengthened by means of the current supply electrode. Further, it is only the very end part of the cermet rod which is embrittled, and much of the current supply electrode is still in contact with the cermet rod which is not embrittled.

It is possible to provide the current supply electrode contacted with the cermet rod without the provision of a weld joint. In this case, the current supply electrode is provided with a hollow tubular section, the internal diameter of which is smaller than the external diameter of the cermet rod. If the hollow tubular section of the current supply electrode is slid over the end of the cermet rod, clearly the compressional forces of the smaller tubular section will lead to a tight frictional fit with the cermet rod. The simplest method of achieving this, is to increase the current supply electrode in temperature with respect to the cermet rod and cause the current supply electrode to expand, and then slide the cermet rod through the hollow tubular section. As the current supply electrode cools, it will clearly contract around the proximal end of the cermet rod therefore holding the two together. This obviously leads to a good electrical connection, and avoids the embrittlement of the cermet rod as no weld has occurred.

It is further possible to provide the end of the hollow tubular section of the current supply electrode with a flared section which facilitates the sliding of the cermet rod within the hollow tubular section.

Further advantageously, the external diameter of the hollow tubular section of the current supply electrode can be made to be greater than the internal diameter of the bore of the protruding plug of the discharge lamp. If the external diameter of the current supply electrode is greater than the bore diameter, it will not be possible to slide the metallic part within the bore of the protruding plug, and therefore the disadvantages of having a metallic material within the ceramic protruding plug are overcome. Further, this inherently leads to a positioning characteristic, in that it will be known how far the cermet rod and discharge electrode tip fastened at the distal end thereof extend from the end of the current supply electrode, and this can be used to exactly position the electrode tip within the internal bulb of the discharge lamp.

It is possible to form the current supply electrode by a simple rolled sheet of conductor to give a hollow tubular section. A further preferable design is to use a strip of conductor which is folded around the cermet rod to form the hollow tubular section. The two ends of the conductor which extend away from the cermet rod can then be fastened together by any known means, for example a weld. This design of supply electrode leads to a solid positioning system, as the extended conductor section will clearly not fit within the bore of the protruding plug.

Further designs for the current supply electrode include a coiled conductive wire. This coiled conductive wire could either be welded or frictionally fit to the proximal end of the cermet rod as desired. The advantage of having a coiled wire is that any contact with this current wire causing it to move, will merely cause the wire to bend rather than transmitting the force to the cermet rod.

Further preferably, as has been discussed somewhat above, it is advantageous that the cermet rod is of a known length such that when the cermet rod and current supply electrode are formed into the combined cermet rod and electrode unit and the discharge electrode tip is directly or with insertion of an additional conductive member attached to the distal end of the cermet rod, this will fit appropriately through the protruding plug of the discharge lamp to exactly position the electrode tip within the internal bulb.

Preferably, the distal end of the cermet rod is provided with an appropriate abutment surface, to which the electrode tip can be readily attached. It is expected that the electrode tip will simply be welded to the distal end of the cermet rod, as this particular weld will be well protected within the lamp itself.

The above problems are further solved by the higher pressure discharge lamp which comprises a ceramic discharge tube which generally forms an internal bulb region. The ceramic discharge tube is also provided with at least one extension in the form of protruding plug, wherein a bore is present through the middle thereof connecting the internal bulb of the lamp to the exterior. Within the bore of the protruding plug is placed the combined cermet rod and electrode unit as described above. In particular, the combined unit is positioned such that the supply electrode abuts to the end of the protruding plug, and only the cermet rod and discharge electrode tip attached to the distal end thereof are within the bore of the protruding plug. Further, this leads to the discharge electrode tip being located exactly in the desired position of the internal bulb region of the discharge lamp.

In a possible, optional embodiment the unit may comprise an additional conductive member between the cermet rod and the electric tip.

It is preferable for the combined cermet rod and electrode unit to be held within the bore of the protruding plug by means of an airtight frit glass seal. This clearly leads to the internal volume of the lamp being sealed to stop escape of the enclosed materials.

Preferably, the external diameter of the current supply electrode in the combined cermet rod and electrode unit is greater than the internal diameter of the bore in the protruding plug. This means that it is not possible for the current supply electrode to be positioned within the bore of the protruding plug, thereby giving the desired positioning characteristics of the combined unit.

A method of making the combined cermet rod and electrode unit is presented by provision of a cermet rod of desired length and diameter. The current supply electrode is provided with a hollow tubular section, and this is slid over the proximal end of the cermet rod. The size of the hollow tubular section is such that it will lead to a physical and electrical contact with the proximal end of the cermet rod.

A preferable method of attaching the supply electrode to the cermet rod is by means of providing the hollow tubular section with an internal diameter approximately the same as the external diameter of the cermet rod. Upon sliding the current supply electrode over the proximal end of the cermet rod a weld can be performed at the very proximal end of the cermet rod to hold the unit together.

A further mechanism by which the unit can be manufactured, is by providing a current supply electrode in which the hollow tubular section has an internal diameter less than the diameter of the cermet rod. By heating the current supply electrode, the material will generally expand. After this expansion, the hollow tubular section is slid over the end of the cermet rod, and after cooling it will grip the proximal end of the cermet rod. This leads to a good frictional fit between the supply electrode and the cermet rod, but avoids the necessity of providing a weld therebetween.

A method of forming a discharge lamp begins by forming the combined cermet and electrode unit as disclosed above. The discharge electrode tip of the lamp is then attached to the distal end of the cermet rod in the combined cermet rod and electrode unit. Numerous methods exist for attaching the discharge electrode tip, and for example a simple weld step is acceptable. A ceramic discharge tube is formed wherein at least one protruding plug with a bore leading through to the internal region of the bulb is provided. The combined cermet rod and current supply electrode is then thread through the bore of the protruding plug such that only the cermet rod and discharge electrode tip are within the protruding plug and lamp. The current supply electrode remains outside the bore of the protruding plug.

In order to seal the entire unit, a frit seal can be made at the end of the protruding plug, so as to keep the combined cermet rod and supply electrode in place.

During the manufacture of the combined cermet rod and electrode unit, the external diameter of the current supply electrode is chosen so as to be larger than the internal diameter of the bore of the protruding plug. This clearly means that the current supply electrode cannot be threaded into the bore of the protruding plug.

### DESCRIPTION OF THE DRAWINGS

FIG. 1 shows one example of the end of a discharge lamp, wherein the combined cermet rod and current supply electrode are shown. In this example, the supply electrode is welded to the cermet rod and extends beyond the proximal end of the cermet rod.

FIG. 2 shows a very similar design to that of FIG. 1, however the current supply electrode does not extend beyond the end of the cermet rod.

FIGS. 3a and 3b show two views of another example of the current supply electrode. The current supply electrode here is shown as a strip of conductor which is bent around the proximal end of the cermet rod.

FIG. 4 shows an example wherein the hollow tubular section of the current supply electrode is smaller than the cermet rod, and has been frictionally fitted over the proximal end of the cermet rod.

FIG. 5 shows another frictional fit between the current supply electrode and cermet rod as seen in FIG. 4, however the current supply electrode is shown with a flared lower end to the hollow tubular section so as to improve fitting of the current supply electrode over the cermet rod.

FIG. 6 shows an example wherein the current supply electrode is provided by a coiled wire.

### DETAILED DESCRIPTION OF THE PREFERRED EMBODIMENT(S)

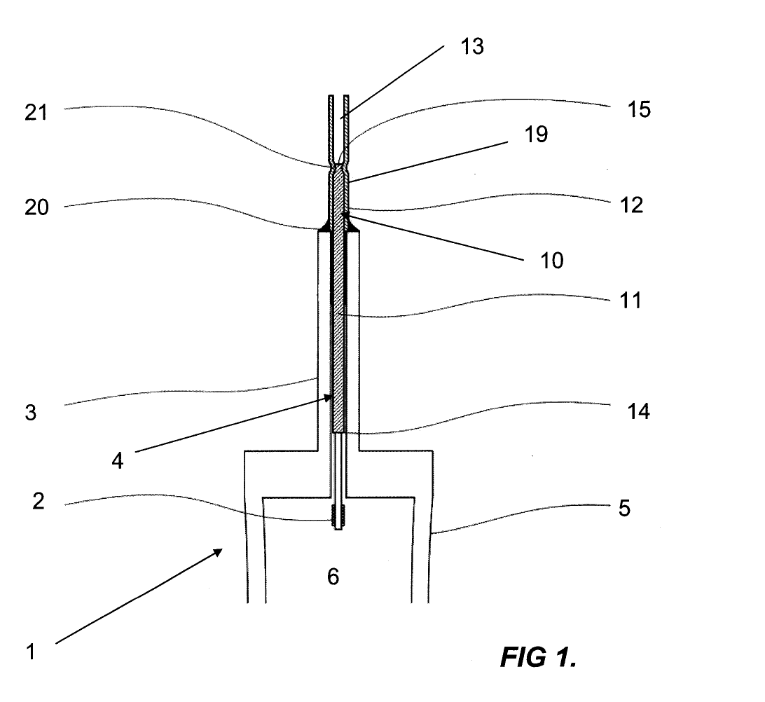

FIG. 1 shows one example of an electrical connection in a high pressure discharge lamp 1. In particular, FIG. 1 shows one electrode of the high pressure discharge lamp 1 which runs from the outside of the lamp 1 into an internal bulb region 6 formed in a ceramic discharge tube 5, which makes up the high pressure discharge lamp 1. High pressure discharge lamps 1 are generally well known in the art, and comprise a bulb region 6 in which is contained an appropriate gas, through which an electric discharge is generated and as a result light is given off. This aspect of high pressure discharge lamps 1 is not considered as limiting in the present invention, and indeed any discharge lamp 1 is susceptible to modification and integration of the present invention's teachings.

As can be seen in FIG. 1, the ceramic discharge tube 5 is possessed of a protruding plug 3 which is comprised of an extended section of the ceramic discharge tube 5, wherein a bore 4 is present through the protruding plug 3. This bore 4 makes fluid contact from the outside of the ceramic discharge tube 5 to the internal bulb region 6 thereof. In particular, the protruding plug 3 is utilized for providing the electrical connection from the outside of the ceramic discharge tube 5 to an electrode tip 2 housed within the internal bulb region 6. The specific design of the electrode tip 2 is also not considered as limiting the present invention. Indeed, any relevant discharge electrode tip 2 is in principle useable with the teachings of the present invention, and therefore no further discussion will be presented about such. Clearly, however, it is necessary for an electrical connection to be made to whichever electrode tip 2 is being utilized, and as previously stated this is provided through the bore 4 of the protruding plug 3.

When in use, high pressure discharge lamps 1 tend to become quite hot. As such, each of the constituent parts of the high pressure discharge lamp 1 will expand as a result of this temperature increase. As is very well known in the art, different materials have different coefficients of expansion. This particular point is of importance as the electrical connection will be provided through the bore 4 of the protruding plug 3. Typically, the bore 4 is not particularly wide, as such the material chosen to make the electrical connection through the bore 4, must be one which will not expand too greatly and cause damage to the ceramic material making up the protruding plug 3.

The present invention is related to providing the electrical connection by means of a cermet rod 11. Cermet materials are well known in the art, and the specific choice of cermet is not considered as a limiting feature of the present invention. Rather, the particular use of a cermet rod 11 in general for providing the electrical connection through the protruding plug 3 is related to the invention. One of the advantages of using a cermet rod 11 is that the coefficient of expansion of the cermet material is very similar to that of the ceramic material used to make up the ceramic discharge tube 5 and protruding plug 3. As such, when the high pressure discharge lamp 1 is in use, the cermet rod 11 is likely to expand by the same amount and in the same way as the protruding plug 3, therefore avoiding any possible risk of damage to the protruding plug 3. Another advantage of the use of cermet materials, is that they are generally resistant to the halide gases being utilized within the high pressure discharge lamp 1.

As can be seen from FIG. 1, in order to make reliable electrical connections between a light housing (not shown) and the high pressure discharge lamp 1, the cermet rod 11 is provided with a current supply electrode 12, usually of a metallic nature. Particularly preferable materials for making up the current supply electrode 12 are those of niobium, tantalum, molybdenum, rhenium, tungsten or alloys thereof. Further advantageously, certain of these materials and alloys generally are permeable to hydrogen. As can be seen FIG. 1, the cermet rod 11 is attached at its proximal end 15 to the current supply electrode 12. In particular, the current supply electrode 12 is positioned over the proximal end of the cermet rod 15, and forms a combined cermet rod and electrode unit 10. It is intended, that this combined cermet rod and electrode unit 10 is manufactured and produced as a combined product unit for use in high pressure discharge lamps 1.

Significant advantages are obtained by the combined cermet rod and electrode unit 10, in that the individual features of the cermet rod 11 and current supply electrode 12 can be tailored according to the specifics of the high pressure discharge lamp 1 into which the combined cermet rod and electrode unit 10 will be used. As is further evident from FIG. 1, the distal end of the cermet rod 14 will be placed within the high pressure discharge lamp 1, and typically will also be positioned within the protruding plug 3. At the end face of the distal end of the cermet rod 14 the discharge electrode tip 2 is attached. The attachment of this electrode tip 2 is by any known technique, and is not considered as a limiting feature of the present invention. Clearly then, the combined cermet rod and electrode unit 10, with the attached electrode tip 2, can be inserted within the bore 4 of the protruding plug 3 of the high pressure discharge lamp 1. Once within the protruding plug 3, the electrode tip 2 is in the appropriate position within the internal bulb region 6 of the ceramic discharge tube 5, and the electrical connection thereto is provided.

The combined cermet rod and electrode unit 10 is composed of a cermet rod 11 of known length and cross-sectional size. Generally, the cermet rod 11 will have a circular cross-section, as this improves the ease of manufacture of both the ceramic discharge tube 5 and protruding plug 3, as well as the cermet rod 11 itself. Obviously, any cross-sectional shape of the cermet rod 11 is appropriate, as long as this fits within the protruding plug 3 of the high pressure discharge lamp 1. At the proximal end of the cermet rod 15, the current supply electrode 12 is positioned. The current supply electrode 12 is possessed of a hollow tubular section 13, wherein the cross-section of this hollow tubular section 13 matches that of the cross-section of the cermet rod 11. In the embodiment shown in FIG. 1, the internal diameter of the hollow tubular section 13 of the current supply electrode 12 is the same as, or very slightly larger than, the external diameter or size of the cermet rod 11. Given these relative sizes, it is clear that the current supply electrode 12 can be slid over the proximal end of the cermet rod 15, thereby forming the combined cermet rod and electrode unit 10. Whilst it is probably secure enough to provide the current supply electrode 12 frictionally fitted to the outside of the cermet rod 11 as described above, it is further advantageous to improve the fit by means of a weld joint 21. Obviously, welding the cermet rod and current supply electrode 12 together will lead to a fully secure combined cermet rod and electrode unit 10.

Unfortunately, cermet materials generally become significantly more brittle after they have been subjected to a welding treatment. This is particularly disadvantageous in high pressure discharge lamps 1, as such a lamp 1 will often be subjected to some forces and knocks during use. One of the main forces applied to the electrode region of a high pressure discharge lamp 1, is that of a bending force as the discharge lamp 1 is placed within and removed from a lamp housing. The present invention overcomes the drawbacks of the cermet rod 11 becoming brittle after a weld, by positioning the weld joint 21 at a location away from the end of the protruding plug 3. As will be clear to the skilled person, the bending moment which would be applied to the combined cermet rod and electrode unit 10 in the high pressure discharge lamp 1 as shown in FIG. 1, will mainly act at the point at which the cermet rod 11 leaves the bore 4 of the protruding plug 3. As, however, a weld joint 21 is formed at a distance away from this position, any turning moments acting on the cermet rod 11 will not interfere with the embrittled region of the cermet rod 11, as this will be away from the point of rotation. As such, a high pressure discharge lamp 1 provided with the combined cermet rod and electrode unit 10 of the present invention will not suffer from brittle fracture of the cermet rod 11 when in use or during transportation.

As is further evident from FIG. 1, it is possible to utilize the fact that the current supply electrode 12 slides over the proximal end of the cermet rod 15 to improve the locating of the electrode discharge tip 2 within the internal bulb region 6 of the ceramic discharge tube 5. Typically, the electrode tip 2 will be of a known size, as will the protruding plug 3 of the ceramic discharge tube 5. Given, therefore, that the distance between the end of the protruding plug 3 and the desired location of the discharge electrode tip 2 is known, it is possible to tailor the combined cermet rod and electrode unit 10 to automatically position the electrode tip 2 at such a position. As can be seen from FIG. 1, the external diameter of the current supply electrode 12 can be chosen so as to be greater than the internal diameter of the bore 4 of the protruding plug 3. If the external diameter of the current supply electrode 12, and in particular the hollow tubular section 13 thereof, is greater than the diameter of the bore 4, it will not be possible to slide the current supply electrode 12 within the bore 4. In itself, this has significant advantages, as it means that the only material of the combined cermet rod and electrode unit 10 present within the bore 4 of the protruding plug 3 will be that of the cermet rod 11. As such, no metallic materials, such as those of the current supply electrode 12, are within the bore 4, and therefore in use the metallic current supply electrode 12 can expand without risk of damage to the protruding plug 3.

Given the above structure of the combined cermet rod and electrode unit 10, in particular that where the current supply electrode 12 has an external diameter greater than the bore 4 of the protruding plug 3, it is possible to choose the length of cermet rod 11 appropriate to automatically position the electrode tip 2. By choosing the length of cermet rod 11 such that the length of cermet rod 11 not covered by the hollow tubular section 13 of the current supply electrode 12, in addition to the length of the electrode tip 2, will automatically be the correct length to extend from the end of the protruding plug 3 to the desired position of the electrode tip 2, manufacture of the high pressure discharge lamp 1 can be significantly improved. That is, the combined cermet rod and electrode unit 10 as shown in FIG. 1, has at least the two following advantages:

1. The weld joint 21 between the cermet rod 11 and the current supply electrode 12 is at a distance removed from the point where any rotational forces would apply to the cermet rod 11. This position is considered as being the point on the cermet rod 11 which passes from the bore 4 of the protruding plug 3.

2. The combined cermet rod and electrode unit 10 automatically positions the electrode tip 2 at the desired position of the internal bulb region 6 in the ceramic discharge tube 5.

A high pressure discharge lamp 1, such as seen in FIG. 1, comprising the combined cermet rod and electrode unit 10, merely needs the combined cermet rod and electrode unit 10 to be slid into the protruding plug 3 until the current supply electrode 12 abuts against the protruding plug 3, and then the combined cermet rod and electrode unit 10 is attached to the high pressure discharge lamp 1. As is seen in FIG. 1, an airtight frit glass seal 20 is provided at the end of the protruding plug 3. This frit seal 20 holds the combined cermet rod and electrode unit 10 in position, as well as providing an airtight seal to the end of the protruding plug 3. The use of a frit glass seal 20 also means that when the high pressure discharge lamp 1 is in use, the frit seal 20 will also expand at the same rate as the ceramic discharge tube 5. As can be seen in FIG. 1, the frit seal 20 also extends partly along the bore 4 of the protruding plug 3 between the interior surface of the protruding plug 3 and the cermet rod 11. This also improves the airtight seal as well as the mechanical strength thereof.

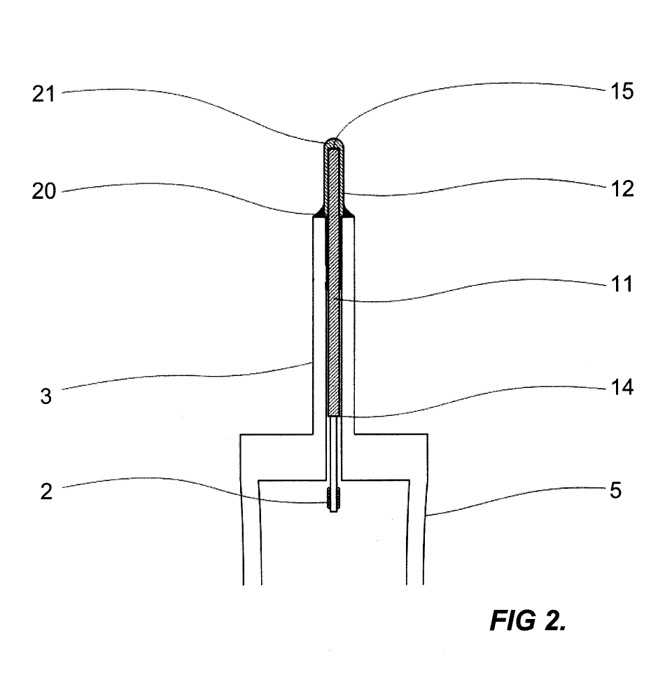

FIG. 2 shows another example of the combined cermet rod and electrode unit 10 of the present invention within a high pressure discharge lamp 1. In the main, this further example is the same as that shown in FIG. 1, however the current supply electrode 12 does not extend beyond the end of the cermet rod 11. In certain circumstances, it is not desirable to have the current supply electrode 12 extend beyond the end of the cermet rod 11 as shown in FIG. 1. The example shown in FIG. 2, merely shows that the current supply electrode 12 can be simply a hollow tubular section 13 running over the relevant section of the cermet rod 11, so as to provide the desired positioning feature of the combined cermet rod and electrode unit 10. Again, the weld joint 21 is provided at a distance on the cermet rod 11 which will be away from the end of the protruding plug 3 of the high pressure discharge lamp 1. Both the examples shown in FIGS. 1 and 2 have the same advantages, and merely differ in that the current supply electrode 12 does not extend beyond the end of the cermet rod 11 in the example shown in FIG. 2.

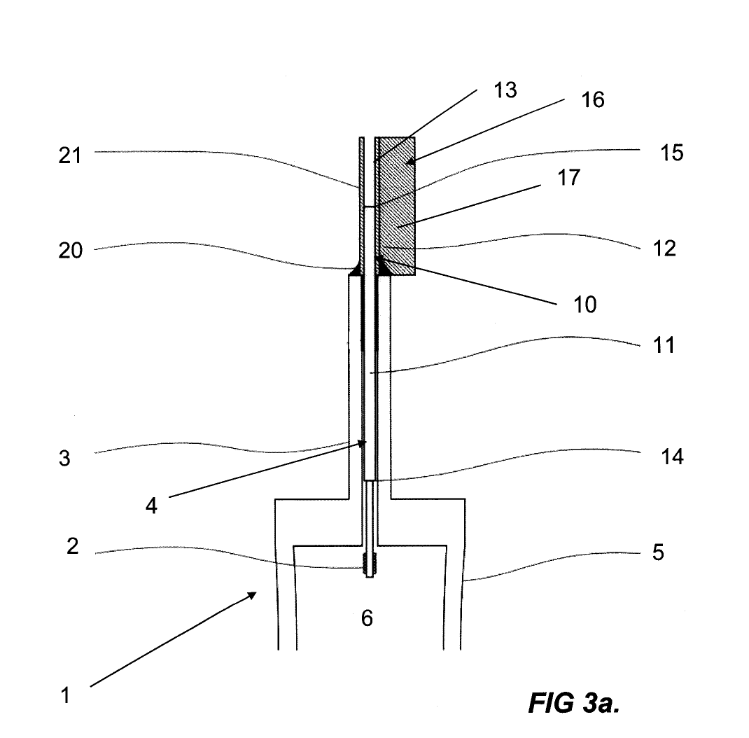

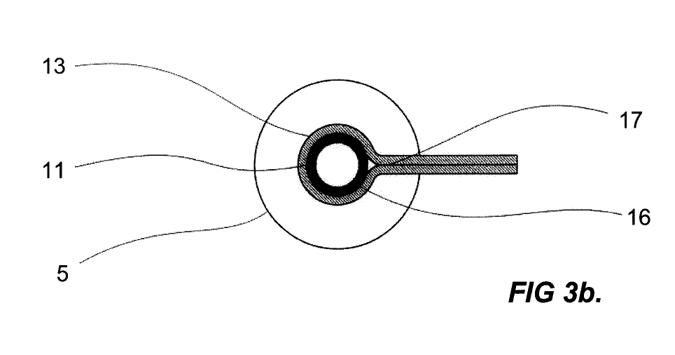

FIG. 3a shows another example of how to form the current supply electrode 12 for the combined cermet rod and electrode unit 10. In the examples shown in FIGS. 1 and 2, the current supply electrode 12 is generally formed by a metallic material drawn into an appropriate configuration to give the hollow tubular section 13. Indeed, this is achieved most simply by drawing a conductive material 19. The example shown in FIGS. 3a and 3b utilizes a strip of conductor 16 which is bent over on itself around the proximal end of the cermet rod 15. This therefore generates the hollow tubular section 13 around the outer surface of the proximal end of the cermet rod 15, and also provides two ends of the strip of conductor 17. In FIG. 3a, the current supply electrode 12 is shown such that the overlapping ends of the conductor strip 17 can be seen. These adjacent ends of the conductor strip 17 when pressed together can be fastened by any technique, and in particular a simple weld is considered as sufficient.

FIG. 3b shows a plan view of the proximal end of the cermet rod 15 with the current supply electrode 12 of this example there around. Obviously, the ends of the conductor strip 17 now stick out from the cermet rod 11, and can be used as an improved positioning means for when the combined cermet rod and electrode unit 10 are positioned within the bore 4 of the protruding plug 3. As can be seen in FIG. 3a, the bottom surface of the ends of the conductor strip 17 will lie against the ends of the protruding plug 3, and this can be used as the depth control for the combined cermet rod and electrode unit 10 to ensure that the electrode tip 2 is located at the appropriate point of the internal bulb region 6. As can be evidenced from this example, it is expected that a further weld joint 21 may be positioned at the very end of the cermet rod 11, such that again the embrittlement caused by such a weld joint will be distanced from the point at the end of the protruding plug 3. Obviously, this therefore improves the resistance to damage of the unit in the same way as the above examples show in FIGS. 1 and 2. In all other aspects, the example shown in FIGS. 3a and 3b is the same as that as shown in FIGS. 1 and 2.

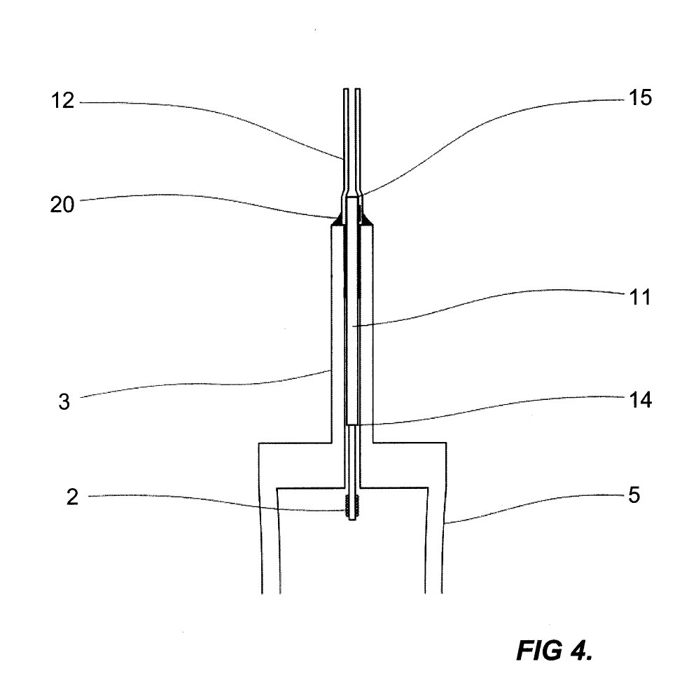

A further example of the combined cermet rod and electrode unit 10 can be seen in FIG. 4. In this example, rather than utilizing a current supply electrode 12 with a hollow tubular section 13 which is the same size or slightly larger than the cermet rod 11, a current supply electrode 12 is used wherein the hollow tubular section 13 is slightly smaller than the end of the cermet rod 11. This can be seen clearly in FIG. 4, wherein the diameter of the hollow tubular section 13 is smaller than the external diameter of the cermet rod 11. In order to manufacture the combined cermet rod and electrode unit 10, the current supply electrode 12 is heated so that it expands. Once the current supply electrode 12 has expanded sufficiently, the hollow tubular section 13 can be slid over the proximal end of the cermet rod 15. After the current supply electrode 12 has cooled, it will shrink to its original size, and therefore will be held frictionally with the proximal end of the cermet rod 15. The compressional forces acting on the cermet rod 11 as a result of the positioned current supply electrode 12 will clearly lead to a sufficient frictional fit, and therefore will stop the combined cermet rod and electrode unit 10 from being readily disassembled. Further, cermet material is particularly resilient to such compressional forces, and therefore will be unaffected by the current supply electrode 12. This technique of providing the combined cermet rod and electrode unit 10 is advantageous, as it dispenses with any necessity of providing a weld between the cermet rod and current supply electrode 12. As has been discussed above, the technique of welding leads to a significant embrittlement of the cermet rod 11, and by avoiding this step there is no weakening to the cermet rod 11 in this example of the combined cermet rod and electrode unit 10.

The frictional fit combined cermet rod and electrode unit 10 of this example can still exhibit the same advantageous properties as the examples shown in FIGS. 1 to 3 wherein a weld joint 21 is provided. If the thickness of the material making the current supply electrode 12 is sufficient such that the external diameter of the hollow tubular section 13 around the proximal end of the cermet rod 15 is greater than the diameter of the bore 4 of the protruding plug 3, the inherent positional characteristic for the electrode tip 2 will arise. That is, the current supply electrode 12 will not fit within the bore 4 of the protruding plug 3, and therefore can be used to position the electrode tip 2 at the distal end of the cermet rod 14 at the appropriate point in the internal bulb region 6. In all other aspects, the example shown in FIG. 4 is the same as those shown in FIGS. 1 to 3.

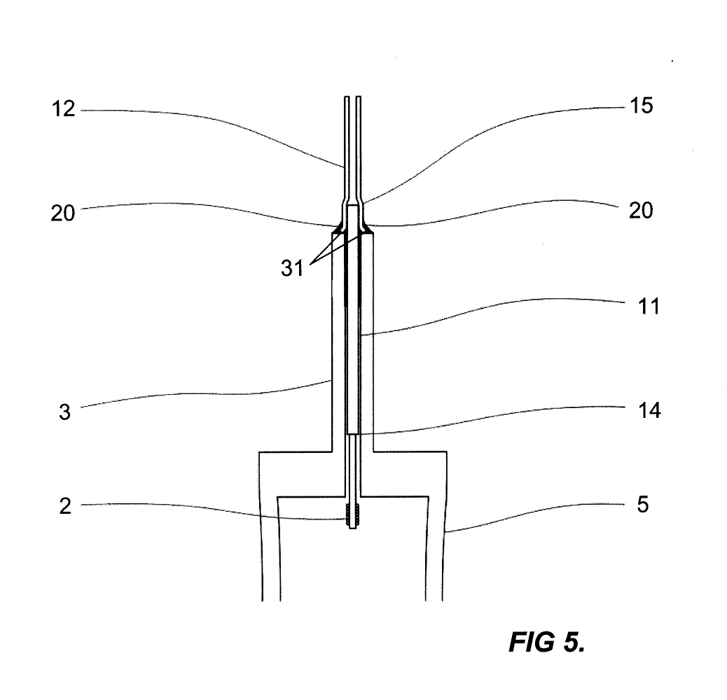

A further advantageous example very similar to that shown in FIG. 4, is shown in FIG. 5. This example only differs from that shown in Figure and described above, in that the end of the current supply electrode 12 which fits over the proximal end of the cermet rod 15 is slightly flared open. By providing the flared section 31 to the current supply electrode 12, not only will the positioning of this electrode 12 over the proximal end of the cermet rod 15 be improved whilst the current supply electrode 12 is heated and expanded, but also the flared end 31 will improve the stopping of the current supply electrode 12 from entering the bore 4 of the protruding plug 3. This is readily seen in FIG. 5.

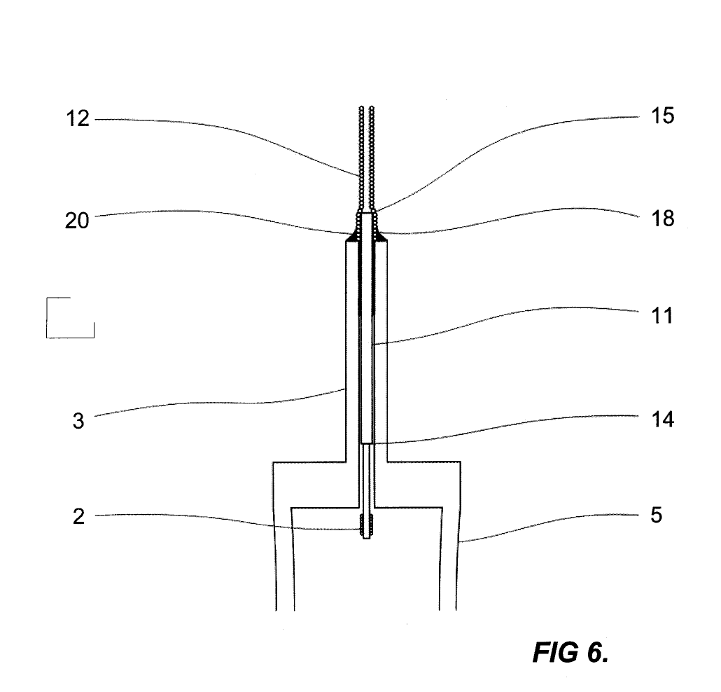

A further example of the current supply electrode 12 can be seen in FIG. 6. The previous current supply electrodes 12 of the examples in FIGS. 1 to 5 have been based around the use of either a strip of conductor 16 or a tubular conductive material 19. The example in FIG. 6, utilizes a coiled conductive wire 18. This coiled conductive wire 18 can be friction fit to the end of the cermet rod 11, as shown in FIG. 6, or could be welded in the same way as has been shown in FIGS. 1 to 3. The advantages of using the coiled conductive wire are that the part of the current supply electrode 12 which is not around the cermet rod 11, will have a flexibility which does not translate to the cermet rod 11. Any forces applied to this section of the current supply electrode 12 will cause the current supply electrode 12 to flex, while transmitting only reduced forces to the cermet rod 11.

As has been discussed above, the current invention relates to the combined cermet rod and electrode unit 10 and production thereof. By producing this individual unit, it is easy to tailor the electrical contact in a high pressure discharge lamp 1. It is intended that the combined cermet rod and electrode unit 10 be separately manufactured by any of the above techniques, so that the unit is prefabricated before integration into a high pressure discharge lamp 1. Once the combined cermet rod and electrode unit 10 has been made, the electrode tip 2 can be attached to the distal end 14, and this can then be positioned into the high pressure discharge lamp 1. The combined cermet rod and electrode unit 10 and electrode tip 2 are thread through the bore 4 of the protruding plug 3 until the current supply electrode 12 abuts against the end of the protruding plug 3. At this point, it is clear that the electrode tip 2 will be in the appropriate position within the internal bulb region 6 of the ceramic discharge tube 5. After filling the internal bulb region 6 with the appropriate chemical fill, the combined cermet rod and electrode unit 10 is attached to the high pressure discharge lamp 1 by means of the frit glass seal 20. This frit glass seal 20 is positioned at the end of the protruding plug 3 and further will cause an airtight seal to stop escape of the halide gas. At this point, the high pressure discharge tube 1 is fabricated and can be sealed into an outer envelop before being used within a lighting housing.

The above description of the examples and figures are not intended to limit the scope of protection of the present invention. Further, it is intended that features from any of the given examples can be utilized in providing a combined cermet rod and electrode unit 10 wherein all of the advantages can be seen. For example, the coiled conductive wire 18 could be used with or without a weld joint 21, and also a weld joint 21 could be combined with the expanded frictional fit current supply electrodes 12. Indeed, the skilled person would be aware that each of the features presented in each example are directed to the production of a combined cermet rod and electrode unit 10 for use in a high pressure discharge lamp 1, and therefore any features can be swapped and exchanged as appears advantageous. The full scope protection for the invention is given by the attached claims.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A combined cermet rod and electrode unit for use in a high pressure discharge lamp comprising:
a cermet rod for connection at its distal end to an electrode tip of the high pressure discharge lamp, and a current supply electrode for forming an electrical connection with the cermet rod,
wherein the current supply electrode is formed with a hollow tubular section which is positioned around a proximal end of the cermet rod in physical and electrical contact therewith.

2. The unit of claim 1, wherein the internal diameter of the hollow tubular section of the current supply electrode is approximately the same as that of the outer diameter of the cermet rod, wherein further the cermet rod and current supply electrode are fixed together by means of a weld joint located at the proximal end of the cermet rod.

3. The unit of claim 1, wherein the internal diameter of the hollow tubular section of the current supply electrode is slightly smaller than the outer diameter of the cermet rod, such that the cermet rod and current supply electrode are fixed together by means of the compressional forces resulting from the hollow tubular section.

4. The unit of claim 1, wherein the end of the hollow tubular section of the current supply electrode which fits over the proximal end of the cermet rod, is provided with a flared section so as to improve the positioning of the current supply electrode over the proximal end of the cermet rod.

5. The unit of claim 1, wherein the outer diameter of the hollow tubular section is chosen so as to be greater than the internal diameter of the bore of a protruding plug of the high pressure discharge lamp into which the unit will be placed.

6. The unit of claim 1, wherein the current supply electrode is provided by a strip of conductor which is folded around the cermet rod to thereby form the hollow tubular section, and wherein the two adjacent ends of the strip of conductor are fastened together by clamping or welding.

7. The unit of claim 1, wherein the current supply electrode is provided by a coiled conductive wire making up the hollow tubular section.

8. The unit of claim 1, wherein the cermet rod is of a length such that the section of the cermet rod which is not covered by the current supply electrode is sufficiently long to pass into the bore of the protruding plug.

9. The unit of claim 1, wherein the cermet rod is of a definite length, and the distal end thereof defines an abutment surface for attachment of the electrode tip or for an additional conductive member of a predetermined length.

10. A high pressure discharge lamp comprising:
a ceramic discharge tube forming an internal bulb region, wherein the ceramic discharge tube further comprises one or more protruding plugs shaped as hollow extensions, wherein the bore of the hollow extensions of the protruding plugs is in direct contact with the internal bulb region of the ceramic discharge tube;
a combined cermet and electrode unit within the bore of the protruding plugs, with the proximal end of the cermet rod and the current supply electrode located on the outside of the ceramic discharge tube and in particular outside of the protruding plugs, such that only the cermet rod enters the bore of the protruding plugs; and
a discharge electrode tip connected with the distal end of the cermet rod and is disposed within the internal bulb region.

11. The lamp of claim 10, wherein the unit may comprise an additional conductive member between the cermet rod and the electrode tip.

12. The lamp of claim 10, wherein the combined cermet and electrode unit is held within the bore of the protruding plugs by means of an airtight frit-sealing glass seal.

13. The lamp of claim 10, wherein the current supply electrode has an outer diameter which is greater than the internal diameter of the bore of the protruding plug, and is located completely outside of the bore.

14. The lamp of claim 13, wherein the length of the cermet rod or of the cermet rod and an additional conductive member of predetermined length is such that its distal end, and the discharge electrode tip connected thereto, is positioned precisely within the ceramic discharge tube by means of the current supply electrode being too wide to fit within the bore of the protruding plugs and thus serving as a length defining mechanism for the cermet rod insertion.

15. A method of making a combined cermet rod and electrode unit for a high pressure discharge lamp comprising the following steps:
providing a cermet rod of a desired length and diameter, and
positioning a current supply electrode over the proximal end of the cermet rod,
wherein the current supply electrode is provided with a hollow tubular section for fitting around the outer surface of the cermet rod and making electrical contact thereto.

16. The method of claim 15, wherein the internal diameter of the hollow tubular section of the current supply electrode is approximately the same as that of the outer diameter of the cermet rod, and the current supply electrode is slid over the proximal end of the cermet rod, and
the cermet rod and current supply electrode are welded together to form a weld joint located at the proximal end of the cermet rod.

17. The method of claim 15, wherein the internal diameter of the hollow tubular section of the current supply electrode is slightly smaller than the outer diameter of the cermet rod, and
the current supply electrode is increased in temperature with respect to the cermet rod, prior to positioning over the cermet rod, thus expanding it sufficiently to allow it to be slid over the proximal end of the cermet rod, and so that after the current supply electrode has cooled and contracted, both the cermet rod and current supply electrode are fixed together by means of the compressional forces as a result of the smaller diameter of the current supply electrode.

18. A method of forming a high pressure discharge lamp, comprising the following steps:
forming a combined cermet rod and electrode unit;
attaching a discharge electrode tip to the distal end of the combined cermet rod and electrode unit;
forming a ceramic discharge tube comprising an internal bulb region, wherein the ceramic discharge tube further comprises one or more protruding plugs shaped as hollow extensions, wherein the bore of the hollow extensions of the protruding plugs is in direct contact with the internal bulb region of the ceramic discharge tube; and
positioning the combined cermet rod and electrode unit within the bore of the protruding plugs, with the proximal end of the cermet rod and current supply electrode located on the outside of the ceramic discharge tube, and with the adjacent end of the bore containing only the cermet rod.

19. The method of claim 18, further comprising the step of forming an airtight frit seal at the end of the protruding plugs so as to seal the inside of the ceramic discharge tube.

20. The method of either of claims 18, wherein the outer diameter of the current supply electrode is greater than the internal diameter of the bore of the protruding plugs.

21. The method of claim 20, wherein the length of the cermet rod and the discharge electrode tip are chosen so that when they are within the protruding plug the distal end of the cermet rod and discharge electrode tip are located at the desired position by means of the current supply electrode being too wide to fit within the bore of the protruding plug.
